(19) United States
(12) Patent Application Publication
(10) Pub. No.: US 2026/0290366 A1
(43) Pub. Date: Sep. 24, 2026

(54) METHOD AND APPARATUS FOR ENHANCING SPEECH USING ARTIFICIAL INTELLIGENCE

(71) Applicant: IUCF-HYU (INDUSTRY-UNIVERSITY COOPERATION FOUNDATION HANYANG UNIVERSITY), Seoul (KR)

(72) Inventors: Joonhyuk CHANG, Seoul (KR); Dahee YANG, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/478,503

(22) PCT Filed: Apr. 25, 2024
(86) PCT No.: PCT/KR2024/005647

§ 371 Date: Oct. 24, 2025

(30) Foreign Application Priority Data
Apr. 25, 2023 (KR) 10-2023-0054348

(51) Int. Cl. G10L 21/02; G10L 15/16; G10L 25/30

(52) U.S. Cl. CPC G10L 21/02; G10L 15/16; G10L 25/30

(57) ABSTRACT

In a speech enhancement method performed by an electronic device using artificial intelligence according to an embodiment of the present disclosure, the method may include: determining a hidden representation for a sequence of an input speech signal in a first neural network; determining speech recognition information based on the hidden representation; receiving the speech recognition information and an input data block in a second neural network; and generating an output data block by combining the speech recognition information and the input data block. (FIG. 8)

### CROSS-REFERENCE TO RELATED APPLICATION

This application is a National Stage of International Application No. PCT/KR2024/005647, filed Apr. 25, 2024, claiming priority based on Korean Patent Application No. 10-2023-0054348 filed Apr. 25, 2023, the contents of which are incorporated herein by reference in their entireties.

### BACKGROUND

### 1. Field

The present disclosure shows a method and an apparatus for enhancing speech using artificial intelligence. Specifically, the present disclosure shows a method for enhancing speech by training artificial intelligence utilizing speech recognition technology.

### 2. Description of the Related Art

The present disclosure relates to a system and a method for providing enhanced speech by removing noise from a speech signal. Recently, a speech recognition technology that collects a speech signal and processes it into data has emerged. The speech recognition technology refers to a technology that enables processing of a human voice into a text format through a program. A speech recognition program may understand and process a speaker's grammar, syntax, and structure. In order to enhance a function of the speech recognition program, a speech enhancement system is needed to enhance speech through pre-processing of a speech signal.

Various types of speech enhancement systems exist, but in particular, an artificial intelligence-based speech enhancement system is attracting attention. However, in an artificial intelligence-based speech enhancement system, training is performed with a goal of improving speech quality, which has led to a problem of deteriorated speech recognition performance. Accordingly, a method is required to simultaneously enhance a speech enhancement function and a speech recognition function. In this regard, a method has been proposed to train the speech enhancement function by applying information related to speech recognition to an artificial intelligence algorithm, but there was a limitation that a speech enhancement model and a speech recognition model had to be jointly trained. Due to the joint training, a new module is combined, and complexity and a size of the model increase, which may cause a problem where usage is limited.

### SUMMARY

The present disclosure aims to provide a method and an apparatus for enhancing the speech enhancement function using speech recognition information.

The present disclosure aims to provide a method for enhancing the speech recognition function and the speech enhancement function while reducing a computational load.

In a speech enhancement method performed by an electronic device using artificial intelligence according to an embodiment of the present disclosure, the method may include: determining a hidden representation for a sequence of an input speech signal in a first neural network; determining the speech recognition information based on the hidden representation; receiving the speech recognition information and an input data block in a second neural network; and generating an output data block by combining the speech recognition information and the input data block.

In an embodiment, the method may further include: combining the output data block and the input data block based on a first probability; and outputting the combined data block.

In an embodiment, the first probability may be set by a learning module, the learning module may include a time pooling operation layer, a linear operation layer, and a softmax operation layer, and the learning module may be pre-trained with an arbitrary input data block and an arbitrary output data block as training data.

In an embodiment, the speech recognition information may include probability distribution information for an output label of each frame of the speech signal.

In an embodiment, the step of generating the output data block by combining the speech recognition information and the input data block may include: determining a weight and a bias through an operation on the speech recognition information; and generating the output data block by operating on the input data block based on the weight and the bias.

In an embodiment, the step of generating the output data block by operating on the input data block using the weight and the bias may be performed in a FiLM (feature-wise linear modulation) layer.

In an embodiment, the first neural network is a CTC (connectionist temporal classification) model, which is a model for speech recognition, and the second neural network is a Temporal Convolutional Network (TCN) included in a Conv-TasNet model which is a model for speech enhancement.

An electronic device according to an embodiment of the present disclosure may include a memory; a modem; and a processor connected to the modem and the memory, wherein the processor may be configured to: determine a hidden representation for a sequence of an input speech signal in a first neural network, determine speech recognition information based on the hidden representation, receive the speech recognition information and an input data block in a second neural network, and generate an output data block by combining the speech recognition information and the input data block.

A program stored on a medium for performing a method for enhancing speech quality through an artificial intelligence algorithm executable by a processor according to an embodiment of the present disclosure, the program may perform: determining a hidden representation for a sequence of an input speech signal in a first neural network; determining speech recognition information based on the hidden representation; receiving the speech recognition information and an input data block in a second neural network; and generating an output data block by combining the speech recognition information and the input data block.

According to an embodiment of the present disclosure, the quality of speech may be enhanced by training artificial intelligence using speech recognition information.

According to an embodiment of the present disclosure, speech clarity may be enhanced by adding a module that selectively utilizes speech recognition information.

### BRIEF DESCRIPTION OF FIGURES

A brief description of each drawing is provided to more fully understand the drawings cited in the detailed description of the disclosure.

FIG. 1 is a conceptual diagram showing a basic principle of an artificial intelligence structure according to an embodiment of the present disclosure.

FIG. 2 is a diagram showing one of the artificial intelligence algorithm structures of a speech enhancement system according to an embodiment of the present disclosure.

FIG. 3 shows a block diagram of an artificial intelligence algorithm for enhancing speech quality according to an embodiment of the present disclosure.

FIG. 4 shows experimental results for speech enhancement for an artificial intelligence model and a conventional model according to an embodiment of the present disclosure.

FIG. 5 shows speech recognition measurement results for an artificial intelligence model and a conventional model according to an embodiment of the present disclosure.

FIG. 6 shows a combination probability when a selective method is used in an artificial intelligence model according to an embodiment of the present disclosure.

FIG. 7 is a block diagram of an electronic device for a speech enhancement system according to an embodiment of the present disclosure.

FIG. 8 is a flowchart illustrating a method for enhancing speech quality according to an embodiment of the present disclosure.

### DETAILED DESCRIPTION OF EXEMPLARY EMBODIMENTS

The technical concept of the present disclosure may be subject to various modifications and may have various embodiments. Specific embodiments are illustrated in the drawings and described in detail herein. However, this is not intended to limit the technical concept of the present disclosure to specific forms, and it should be understood to include all modifications, equivalents, and alternatives within the scope of the technical concept of the present disclosure.

In describing the technical concept of the present disclosure, detailed descriptions of related known technologies may be omitted if they are deemed to obscure the gist of the present disclosure. In addition, numerical labels (e.g., first, second, etc.) used in the description are merely for distinguishing one component from another.

As used herein, when one component is described as being “connected to” or “coupled to” another component, it should be understood that the component may be directly connected or coupled to the other component, or may be indirectly connected or coupled through another component, unless otherwise stated.

The terms such as “~unit,” “~mechanism,” and “~er” described herein refer to a unit that processes at least one function or operation, and may be implemented with hardware such as a Processor, a Micro Processor, a Micro Controller, a Central Processing Unit (CPU), a Graphics Processing Unit (GPU), an Accelerate Processor Unit (APU), a Digital Signal Processor (DSP), an Application Specific Integrated Circuit (ASIC), a Field Programmable Gate Array (FPGA), or the like, software, or a combination of hardware and software.

And it is intended to clarify that the division of components in the present application is merely based on the main function performed by each component. That is, two or more components to be described below may be combined into one component, or one component may be provided by being divided into two or more parts according to more subdivided functions. Additionally, the classification of the components described herein is merely based on their respective main functions. Accordingly, two or more components may be combined into one, or a single component may be subdivided into two or more subcomponents by function. Each component may perform not only its main function but also part or all of the functions performed by other components. Conversely, part of the main function of a component may be dedicated to and performed by another component.

In describing embodiments of the present disclosure, detailed descriptions of related functions or configurations will be omitted when it is determined that they may unnecessarily obscure the gist of the present disclosure. The terms to be described later are terms defined in consideration of functions in the present disclosure, and may vary according to the intention or custom of the user or operator, and the like. Therefore, the definition should be made based on the entire content of the present specification.

For the same reason, some components in the attached drawings may be exaggerated, omitted, or schematically illustrated. In addition, the size of each component does not fully reflect the actual size. In each drawing, the same reference numerals are assigned to the same or corresponding components.

The advantages and features of the present disclosure and the method of achieving them will become clear by referring to the embodiments described in detail below with the attached drawings. However, the present disclosure is not limited to the embodiments disclosed below, but may be implemented in various different forms; rather, the embodiments are provided so that the description of the present disclosure is complete and to fully convey the scope of the invention to those skilled in the art to which the embodiments of the present disclosure pertain, and the scope to be claimed in the present disclosure is defined only by the scope of the claims.

At this time, it will be understood that each block of the flow chart illustrations, and combinations of the blocks in the flow chart illustrations, may be executed by computer program instructions. These computer program instructions may be mounted on a processor of a general purpose computer, a special purpose computer, or other programmable data processing equipment, so the instructions performed through the processor of the computer or other programmable data processing equipment create means for performing the functions described in the flowchart block(s). These computer program instructions may also be stored in a computer-usable or computer-readable memory that can direct a computer or other programmable data processing equipment to implement the functions in a particular manner, so the instructions stored in the computer-usable or computer-readable memory are capable of producing an article of manufacture including instruction means for performing the functions described in the flowchart block(s). The computer program instructions may also be loaded onto a computer or other programmable data processing equipment to cause a series of operational steps to be performed on the computer or other programmable data processing equipment to produce a computer implemented process such that the instructions that execute on the computer or other programmable data processing equipment provide steps for implementing the functions described in the flowchart block(s).

Also, each block may represent a module, segment, or portion of code that includes one or more executable instructions for implementing the specified logical function(s). It should also be noted that in some alternative implementations, the functions noted in the blocks may occur out of the order noted. For example, two blocks shown in succession may in fact be executed substantially concurrently or the blocks may sometimes be executed in the reverse order, depending upon the functionality involved.

The term ‘unit or part’ used in the present disclosure refers to a hardware component such as software or a Field-Programmable Gate Array (FPGA) or an Application Specific Integrated Circuit (ASIC), and the ‘unit’ may be configured to perform specific roles. However, a ‘unit’ is not limited to software or hardware. A ‘unit’ may be configured to reside on an addressable storage medium and configured to execute one or more processors. Thus, by way of example, a ‘unit’ may include components such as software components, object-oriented software components, class components, and task components, as well as processes, functions, attributes, procedures, subroutines, segments of program code, drivers, firmware, microcode, circuitry, data, databases, data structures, tables, arrays, and variables. The functionality provided by the components and ‘units’ may be combined into a smaller number of components and ‘units’ or further separated into additional components and ‘units’. Furthermore, the components and ‘units’ may be implemented to reproduce one or more CPUs within a device or a secure multimedia card. In an embodiment, a ‘unit’ may include one or more processors and/or devices. Hereinafter, embodiments according to the technical idea of the present disclosure will be described in detail in order.

Hereinafter, various embodiments according to the technical concept of the present disclosure will be described in detail.

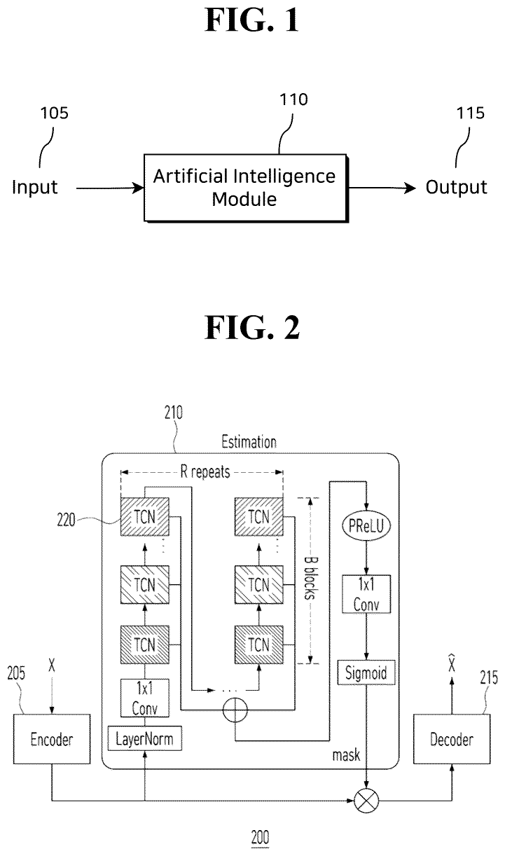

FIG. 1 is a conceptual diagram showing a basic principle of an artificial intelligence structure according to an embodiment of the present disclosure.

Referring to FIG. 1, the basic principle in which learning is performed in the artificial intelligence structure is shown.

Artificial intelligence technology refers to a technology for solving cognitive problems mainly associated with human intelligence, such as learning, problem solving, and recognition. Artificial intelligence may be trained through a machine learning method called Machine learning (ML) and a deep learning method called Deep learning (DL). Machine learning is mainly used for techniques used in pattern recognition and learning, and refers to an algorithm that learns recorded data and predicts subsequent data based on the recorded data. Machine learning refers to a technology that learns by itself from data without being based on pre-defined rules or patterns. On the other hand, deep learning is a field of machine learning and differs in that it processes data based on an Artificial Neural Network (ANN). Because deep learning uses an artificial neural network, it may process more complex and sophisticated operations than machine learning. The types of algorithms for deep learning may include a Convolution neural network (CNN), an Artificial Neural Network (ANN), and a Recurrent Neural Network (RNN).

Referring to FIG. 1, the artificial intelligence structure may be represented as an artificial intelligence module 110. The artificial intelligence module 110 receives predetermined input data 105, performs training through a predetermined method defined in the module, and outputs output data 115 for the training result. According to an embodiment, the input data 105 may include predetermined data, a speech signal, and an input sequence. The output data 115 may include an enhanced speech signal, speech recognition information (for example, posterior probability), and the like.

FIG. 2 is a diagram showing one of the artificial intelligence algorithm structures of a speech enhancement system according to an embodiment of the present disclosure.

The artificial intelligence algorithm 200 of FIG. 2 may be one type of the artificial intelligence module 110 of FIG. 1.

The artificial intelligence algorithm 200 of FIG. 2 may be Conv-TasNet, which is a type of Convolutional Neural Network (CNN). The Conv-TasNet may represent a source separation model that processes a speech signal using deep learning in a frequency domain. Specifically, the Conv-TasNet may process (refine) the speech signal, and the refined signal may be utilized in applications such as speech recognition, music analysis, and music generation.

Referring to FIG. 2, the artificial intelligence algorithm 200 may include an encoder module 205, an estimation module 210, and a decoder module 215. The encoder module 205 may convert a raw waveform (input audio signal) in a time domain into a feature in a latent domain. For example, the encoder module 205 may be composed of a 1D (dimension) convolution layer, but is not limited thereto.

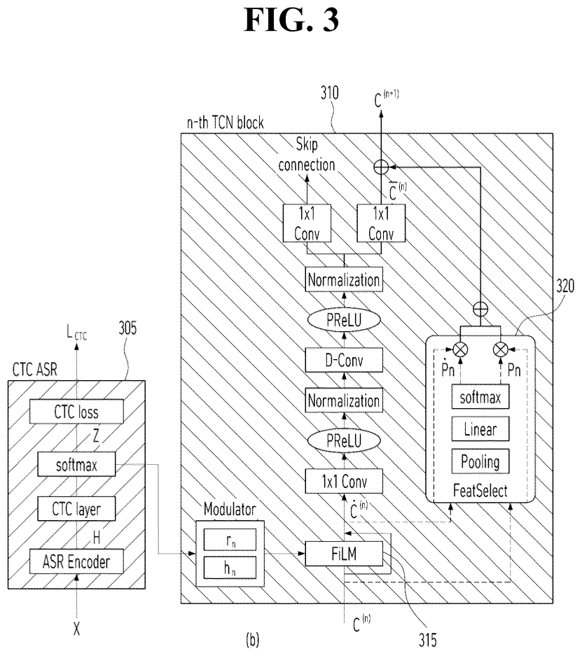

The estimation module 210 may estimate a source signal based on the feature of the signal extracted by the encoder module 205. The estimation module 210 may include a plurality of temporal convolution networks (TCN) 220. The TCN 220 may have a structure for acquiring a temporal characteristic of the input signal. The TCN 220 is mainly used in modeling time-series data, and may perform training on the data according to time. Each TCN 220 block may include at least one of a 1×1 convolution step, a parametric rectified linear unit (PReLU) non-linear function step, a normalization step, a depth-wise dilated convolution (D-conv) step, and a residual connection path step, as shown in FIG. 3 later. However, each step may not necessarily be included. A mask estimated in the estimation module 210 may be multiplied by an output from the encoder module 205 to output an enhanced latent domain feature, and the output feature may be converted back into a time domain signal through the decoder module 215.

The decoder module 215 may reconstruct a separated source signal. The decoder module 215 may convert the source signal into a time domain and reconstruct it to generate an audio signal.

According to an embodiment, the artificial intelligence algorithm 200 of FIG. 2 may be trained in an end-to-end manner, and may be trained in a direction that minimizes a difference between an input signal and each source signal.

FIG. 3 shows a block diagram of an artificial intelligence algorithm for enhancing speech quality according to an embodiment of the present disclosure.

A TCN structure 310 of FIG. 3 may be the same structure as the TCN 220 structure of FIG. 2.

Referring to FIG. 3, an entire artificial intelligence algorithm structure 300 according to an embodiment of the present disclosure may include a CTC (Connectionist Temporal Classification) structure 305 and a TCN structure 310.

According to an embodiment, the CTC structure 305 is also called CTC ASR (Automatic Speech Recognition), and may represent a model that converts an input speech signal into a text sequence. That is, the CTC structure 305 represents an end-to-end speech recognition system that predicts a target sequence from an input speech. The CTC 305-based speech recognition system may perform a speech recognition function without explicit alignment information between an input speech sequence and a target sequence. The CTC structure 305 may consider a probability distribution for all possible sequences. That is, the CTC structure 305 may consider a probability distribution of all possible output sequences for a given input speech sequence. An equation for calculating this is as follows.

$${P}_{CTC} ( Y \vert X ) = {\sum }_{\hat{y} ∈ B ( Y , X )} {\prod }_{t = 1}^{T} P ( {\hat{y}}_{t} \vert X ) \qquad [ Equation 1 ]$$

In Equation 1, X denotes an input sequence, Y denotes a target sequence, and B(Y,X) may mean all possible paths in which X may be mapped to Y. If all the predicted output labels ŷₜ for T frames are multiplied and then all possible paths are summed, it may be the probability that the target sequence Y appears when the input sequence X is given. Here, X may be a speech recognition-related feature generated from the input speech signal, and Y may be text information. ŷₜ may represent a label predicted at a t-th frame when X has T frames.

The CTC speech recognition system may be trained in a direction in which a negative log value of the probability is minimized, and an equation for calculating a loss in the training is as follows.

$${L}_{C T C} = - ln {P}_{CTC} ( Y \vert X ) \qquad [ Equation 2 ]$$

According to an embodiment, the CTC structure 305 may extract a probability vector containing context information of the speech signal and utilize the probability vector for training the speech enhancement system. The probability vector may represent a posterior probability of a CTC output label for each frame. The CTC structure 305-based posterior probability may be determined through the following equation.

$$Z = Softmax ( Linear ( H ) ) \qquad [ Equation 3 ]$$

Here, H denotes a hidden representation of an encoder module of a speech recognition model, which is an intermediate latent feature output during a training process of the speech recognition system, and Z (hereinafter Z), which is the posterior probability, may be output by performing linear and softmax operations on H. Z denotes a CTC class label distribution matrix for each frame, and may be utilized as conditioning information for each TCN block of an estimation module of the speech enhancement model. Z may include probability distribution information for an output label of each frame of the speech signal.

Z output from the CTC structure 305 may be input as conditioning information to the TCN 310. Z may have a feature modified through a linear layer. At this time, a weight value may be output through a linear operation rₙ(Z), and a bias value may be output through a linear operation hₙ(Z). The output weight value and bias value and an input C⁽ⁿ⁾ to the TCN block may be combined through a feature-wise linear modulation (FiLM) layer 315. The FiLM 315 is one of the conditioning methods utilized to combine two different features, and may be calculated by the following equation.

$$FiLM ( {C}^{( n )} , Z ) = {C}^{( n )} ⊙ {r}_{n} ( Z ) + {h}_{n} ( Z ) \qquad [ Equation 4 ]$$

Here, C⁽ⁿ⁾ denotes an input of an n-th TCN block, and the speech recognition information Z and C may be combined through a linear operation. An operation of the FiLM 315 may be performed with the same mechanism as the input of the existing TCN block. A latent feature obtained as an output of the FiLM 315 may be denoted as Ċ⁽ⁿ⁾.

According to an embodiment, the TCN block 310 may include a 1×1 convolution step, a parametric rectified linear unit (PReLU) non-linear function step, a normalization step, a depth-wise dilated convolution (D-conv) step, and a residual connection path step. Additionally, a selective conditioning method may be applied to the TCN block. When utilizing speech recognition information and applying it to the speech enhancement system, it may be more efficient to select and use only the necessary amount of the obtained latent feature for training, rather than unconditionally using the obtained latent feature. In this regard, a FeatSelect module 320 to which the selective conditioning method is applied may be utilized. The TCN block 310 may selectively include the FeatSelect module 320. The FeatSelect module 320 may include a time pooling step, a linear step, and a softmax step. The FeatSelect module 320 may use a method of combining two features by receiving C⁽ⁿ⁾, which is the input of the TCN block, and Ċ⁽ⁿ⁾, which is the latent feature obtained through FiLM conditioning, as inputs. A combined result value may be delivered to a residual connection path for the next TCN block. Equations applied to the FeatSelect module 320 are as follows.

$$FeatSelect ( {\dot{C}}^{( n )} , {C}^{( n )} ) = {\dot{C}}^{( n )} ⊙ {\dot{P}}^{( n )} + {C}^{( n )} ⊙ {P}^{( n )} \qquad [ Equation 5 ]$$

$${\dot{P}}_{n} , {P}_{n} = Softmax ( Linear ( Pooling ( {\dot{C}}^{( n )} , {C}^{( n )} ) ) ) \qquad [ Equation 6 ]$$

$${C}^{( n + 1 )} = {\tilde{C}}^{n} + FeatSelect ( {\dot{C}}^{( n )} , {C}^{( n )} ) \qquad [ Equation 7 ]$$

Here, \dot{P}⁽ⁿ⁾ and P⁽ⁿ⁾ represent probabilities that the conditioned feature and the original input feature are combined, respectively, both representing probability values between 0 and 1, and the sum of the two probabilities is always set to be 1. The feature combined from the FeatSelect module 320 is added to the calculated feature of the TCN block and is used as the input feature of the next TCN block. Speech calculated according to the above procedures shows better performance than other existing models, as quality and clarity are enhanced.

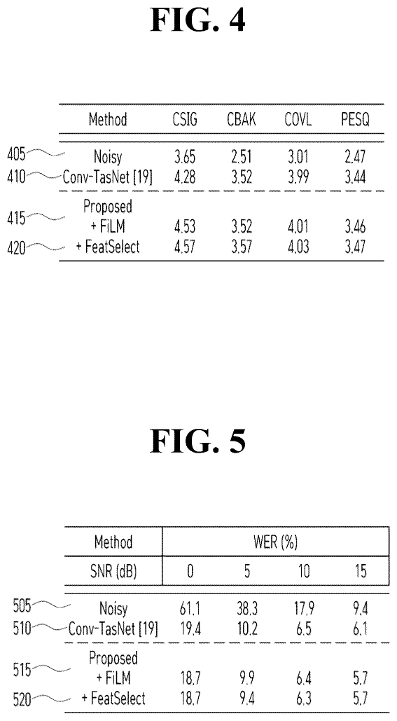

FIG. 4 shows experimental results for speech enhancement for an artificial intelligence model and a conventional model according to an embodiment of the present disclosure.

A Wall Street Journal (WSJ) public dataset was used as the dataset in FIG. 4. A speech recognizer model was trained with the WSJ dataset, and label information for each frame was extracted and applied to the speech enhancement system.

The comparison results show a Noisy 405 method to which the speech enhancement system is not applied, a conventional Conv-TasNet 410 model method, a FiLM 415 method that applies speech recognition information to the speech enhancement system, and a FeatSelect 420 method that selectively utilizes speech recognition information.

As experimental methods, CSIG (Clean Speech Intelligibility Guarantee), CBAK (Composite Background Noise Attenuation Key), COVL (Coverage), and PESQ (Perceptual Evaluation of Speech Quality), which are commonly used as speech quality evaluation indices, were used.

Both the proposed FiLM method and the FeatSelect method in the present disclosure show improvement in numerical values in all fields, and in particular, the numerical value in the selective FeatSelect method significantly increased. Among them, CSIG, which indicates a degree of speech distortion, increased most significantly compared to the conventional model.

FIG. 5 shows speech recognition measurement results for an artificial intelligence model and a conventional model according to an embodiment of the present disclosure.

A WSJ public dataset was used as the dataset in FIG. 5. A speech recognizer model was trained with the WSJ dataset, and label information for each frame was extracted and applied to the speech enhancement system, and then the speech recognition function was measured.

The comparison results show a Noisy 505 method to which the speech enhancement system is not applied, a conventional Conv-TasNet 510 model method, a FiLM 515 method that applies speech recognition information to the speech enhancement system, and a FeatSelect 520 method that selectively utilizes speech recognition information.

As a measurement result value, a word error rate (WER) was measured, which may be calculated as in the following equation.

$$WER = ( S + D + I ) / N \qquad [ Equation 8 ]$$

Here, D denotes the number of words incorrectly deleted in the speech-recognized text, S denotes the number of words incorrectly substituted in the speech-recognized text, I denotes the number of words incorrectly added in the speech-recognized text, and N denotes the number of words in the correct text.

It can be confirmed that the WER value decreases in all fields for both the proposed FiLM method and the FeatSelect method in the present disclosure, and in particular, the numerical value in the selective FeatSelect method further decreased.

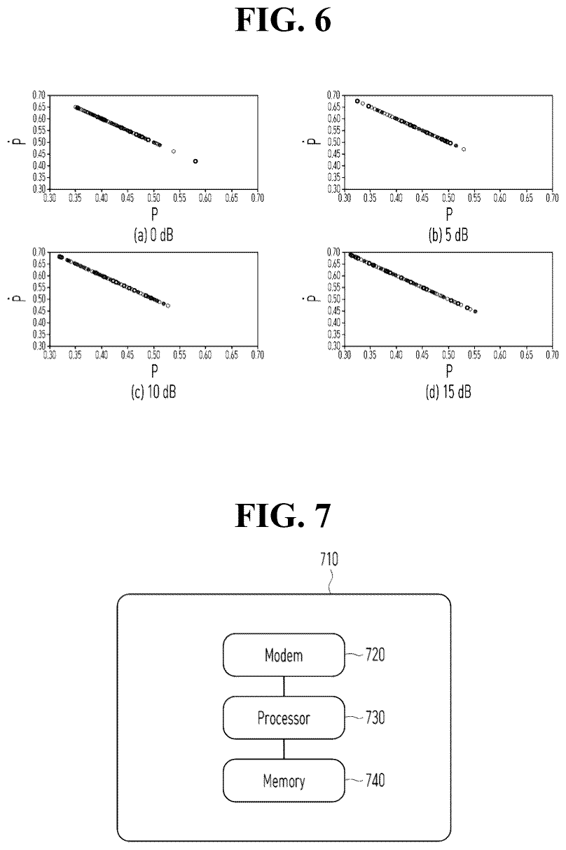

FIG. 6 shows a combination probability when a selective method is used in an artificial intelligence model according to an embodiment of the present disclosure.

In the graphs of FIG. 6, an x-axis represents a probability of combining the existing input feature, and a y-axis represents a probability of combining the feature combined with the speech recognition information, and the sum of the two probabilities is 1. Through the fact that the distribution is biased toward the second quadrant at all SNRs (signal noise ratio), it can be confirmed that the feature combined with the speech recognition information may be more helpful in enhancing the performance of the speech enhancement model.

FIG. 7 is a block diagram of an electronic device for a speech enhancement system according to an embodiment of the present disclosure.

Referring to FIG. 7, an electronic device 710 may include a modem 720, a memory 740, and a processor 730.

The modem 720 may be a communication modem that is electrically connected to other electronic devices to enable mutual communication. In particular, the modem 720 may receive a data input and transmit it to the processor 730, and the processor 730 may store the input data value in the memory 740. Additionally, the data value output by the artificial intelligence algorithm trained in the system may be transmitted to another electronic device.

The memory 740 is a configuration in which various information and program instructions for the operation of the electronic device 710 are stored, and may be a storage device such as a Hard Disk or an SSD (Solid State Drive). In particular, the memory 740 may store one or more data input values input from the modem 720 under the control of the processor 730. In addition, the memory 740 may store program instructions such as an artificial intelligence algorithm for speech recognition enhancement and speech quality enhancement executable by the processor 730.

The processor 730 is configured with at least one processor, and may train an artificial intelligence algorithm for speech recognition enhancement and an artificial intelligence algorithm for speech quality enhancement using data and program instructions stored in the memory 740, and calculate data using the algorithms. The processor 730 may control and calculate all artificial intelligence algorithms (for example, Conv-TasNet, CTC, TCN) described in FIGS. 1 to 6.

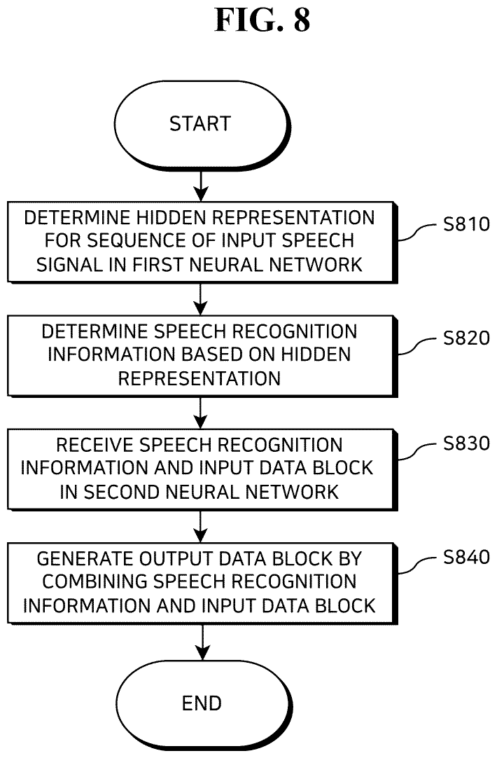

FIG. 8 is a flowchart illustrating a method for enhancing speech quality according to an embodiment of the present disclosure.

Hereinafter, with reference to FIG. 8, the training operation of the artificial intelligence algorithm of the electronic device and the speech recognition enhancement and speech quality enhancement method described with reference to FIGS. 1 to 7 are summarized and described. Each operation is not an operation that must be included in a series of processes, and only a part of the operations may be configured and operate depending on a situation.

In step S810, a hidden representation (for example, H in FIG. 3) for a sequence of an input speech signal may be determined in a first neural network to train artificial intelligence. The artificial intelligence may be an artificial intelligence neural network used in a speech recognition system and a speech enhancement system. The first neural network may be a CTC (connectionist temporal classification) model, which is a model for speech recognition.

In step S820, speech recognition information may be determined based on the hidden representation. The speech recognition information may be a posterior probability obtained by performing a linear operation and a softmax operation on the determined hidden representation. The speech recognition information may include probability distribution information for an output label of each frame of the speech signal.

In step S830, the speech recognition information and an input data block may be received in a second neural network. The second neural network may represent a Temporal Convolutional Network (TCN) block included in a Conv-TasNet model, which is a model for speech enhancement. The input data block may be data output from a previous TCN block. A feature of the speech recognition information may be transformed through a linear operation. The speech recognition information may determine a weight and a bias through an operation.

In step S840, an output data block may be generated by combining the speech recognition information and the input data block. The operation of combining the speech recognition information and the input data block may be performed in a FiLM layer. The output data block and the input data block may be combined based on a first probability, and the combined data block may be output. The first probability may be set by a learning module, the learning module may include a time pooling operation layer, a linear operation layer, and a softmax operation layer, and the learning module may be pre-trained with an arbitrary input data block and an arbitrary output data block as training data. The learning module may be the same as the FeatSelect module 320 of FIG. 3.

While the present invention has been described in detail with reference to preferred embodiments, the invention is not limited to the disclosed embodiments. Various modifications and alterations may be made by those skilled in the art without departing from the spirit and scope of the invention.

What is claimed is:

1. A speech enhancement method performed by an electronic device using artificial intelligence, the method comprising:
determining a hidden representation for a sequence of an input speech signal in a first neural network;
determining speech recognition information based on the hidden representation;
receiving the speech recognition information and an input data block in a second neural network; and
generating an output data block by combining the speech recognition information and the input data block.

2. The method of claim 1, further comprising:
combining the output data block and the input data block based on a first probability; and
outputting the combined data block.

3. The method of claim 2, wherein:
the first probability is set by a learning module,
the learning module includes a time pooling operation layer, a linear operation layer, and a softmax operation layer, and
the learning module is pre-trained with an arbitrary input data block and an arbitrary output data block as training data.

4. The method of claim 1, wherein the speech recognition information includes probability distribution information for an output label of each frame of the speech signal.

5. The method of claim 1, wherein the step of generating the output data block by combining the speech recognition information and the input data block includes:
determining a weight and a bias through an operation on the speech recognition information; and
generating the output data block by operating on the input data block based on the weight and the bias.

6. The method of claim 5, wherein the step of generating the output data block by operating on the input data block using the weight and the bias is performed in a FiLM (feature-wise linear modulation) layer.

7. The method of claim 1, wherein:
the first neural network is a CTC (connectionist temporal classification) model, which is a model for speech recognition, and
the second neural network is a Temporal Convolutional Network (TCN) block included in a Conv-TasNet model, which is a model for speech enhancement.

8. An electronic device comprising:
a memory;
a modem; and
a processor connected to the modem and the memory, wherein the processor is configured to:
determine a hidden representation for a sequence of an input speech signal in a first neural network,
determine speech recognition information based on the hidden representation,
receive the speech recognition information and an input data block in a second neural network, and
generate an output data block by combining the speech recognition information and the input data block.

9. The electronic device of claim 8, wherein the processor is further configured to:
combine the output data block and the input data block based on a first probability, and
output the combined data block.

10. The electronic device of claim 9, wherein:
the first probability is set by a learning module,
the learning module includes a time pooling operation layer, a linear operation layer, and a softmax operation layer, and
the learning module is pre-trained with an arbitrary input data block and an arbitrary output data block as training data.

11. The electronic device of claim 8, wherein the speech recognition information includes probability distribution information for an output label of each frame of the speech signal.

12. The electronic device of claim 8, wherein the processor is configured to:
determine a weight and a bias through an operation on the speech recognition information, and
generate the output data block by operating on the input data block based on the weight and the bias.

13. The electronic device of claim 12, wherein the processor is configured to:
generate the output data block by operating on the input data block based on the weight and the bias in a FiLM (feature-wise linear modulation) layer.

14. The electronic device of claim 8, wherein:
the first neural network is a CTC (connectionist temporal classification) model, which is a model for speech recognition, and
the second neural network is a Temporal Convolutional Network (TCN) block included in a Conv-TasNet model, which is a model for speech enhancement.

15. A program stored on a medium for performing a method for enhancing speech quality through an artificial intelligence algorithm executable by a processor, the program performing:
determining a hidden representation for a sequence of an input speech signal in a first neural network;
determining speech recognition information based on the hidden representation;
receiving the speech recognition information and an input data block in a second neural network; and
generating an output data block by combining the speech recognition information and the input data block.
